(19) United States
(12) Patent Application Publication
(10) Pub. No.: US 2004/0075190 A1
(43) Pub. Date: Apr. 22, 2004

(54) Method for making melamine container with dual-side patterns

(76) Inventor: Ching-Lin Tai, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/270,613

(22) Filed: Oct. 16, 2002

(51) Int. Cl. B29C 45/16

(52) U.S. Cl. 264/245; 264/255; 264/328.8

(57) ABSTRACT

A method for making a melamine container with dual-side patterns including four steps, which are (1) making a first part of a melamine container, (2) forming patterns on the first container part, (3) making a second part of the melamine container, and (4) forming patterns on the second container part. More specifically, the first container part is formed in a first mold, and a male part of the first mold is removed to uncover an inner side of the first container part for allowing patterns to be attached on the inner side. Then, the first container part is repositioned in a second mold so that the second container part is formed over the first container part. A female part of the second mold is removed for allowing patterns to be attached to the outer side of the second container part.

### BACKGROUND OF THE INVENTION

1. Field of the Invention

The present invention relates to a method for making melamine container with dual-side patterns, more particularly a method for making melamine container with dual-side patterns, which uses two moulds, and two injection molding machines such that the pattern attaching process can be incorporated into the present method for the container product to be provided with patterns on both the inner and the outer sides.

2. Brief Description of the Prior Art

Melamine is often used as a material in manufacturing of house containers such as bowls. Such melamine containers are usually manufactured by means of injection molding. Melamine containers are single color after molding therefore they look relatively monotonous. In order to make melamine containers more attractive and fancy, a pattern attaching process is applied, wherein patterns, drawings or characters are attached to the surfaces of the melamine containers.

Patterns are attached to melamine containers directly while the containers are still supported on the molding machine after the molding process; removal of one of the parts of the mould from the other uncovers one side of the melamine containers for allowing patterns to be attached to the melamine containers. The above method allows melamine containers to be manufactured with the patterns on the same locations and with uniform quality. However, patterns can be attached to only one side of melamine containers with this method because only one of the mold parts can be removed, and only one side of the containers uncovered, the containers are still joined to the other mold part on the course of pattern attaching.

If melamine containers are removed from the mold for attaching patterns, it would be difficult for the melamine containers to have patterns on the same locations and uniform quality, and the labor cost would increase. Consequently, melamine containers having dual-side patterns are seldom available, and consumers can only get melamine containers having single-sided patterns, which cannot help increase attractiveness of melamine containers sufficiently.

Referring to FIGS. 1, 2, and 3, another conventional method for making melamine containers uses two female mould parts, and one male mould part so that an inner and an outer sides of a container can be made in separate injection molding processes and different colors. However, the container product still can be formed with patterns on single side.

### SUMMARY OF THE INVENTION

It is a main object of the present invention to provide a method for making a melamine container, which allows patterns to be attached to both sides of the melamine container while the melamine container is being supported on a mold, with which the melamine container is manufactured.

It is another object of the present invention to provide a method for making a melamine container with dual-side patterns, in which both the molding and pattern attaching processes are relatively smooth and uninterrupted.

The present method for making a melamine container with dual-side patterns includes the following steps: making a first part of a melamine container, forming patterns on the first container part, making a second part of the melamine container, and forming patterns on the second container part.

In the first step, the first container part is molded by means of injecting melamine materials into a first mold including a male part and a female part.

In the second step, the male part of the first mold is separated from the first container part, and a pattern is attached to an inner side of the first container part.

In the third step, the first container part is repositioned in a second mold, which consists of male, and female parts, and the second container part is formed over the first container part by means of injecting melamine materials into the second mold.

In the fourth step, the female part of the second mold is separated from the container to uncover an outer side of the second container part, and a pattern is attached to the outer side of the second container part.

### BRIEF DESCRIPTION OF THE DRAWINGS

The present invention will be better understood by reference to the accompanying drawings, wherein:

FIG. 1 is a view illustrating a first step of a conventional method for making a dual-color melamine container with two female mould parts, and one male mould part,

FIG. 2 is a view illustrating a second step of the conventional method for making a dual-color melamine container,

FIG. 3 is a view illustrating a third step of the conventional method for making a dual-color melamine container,

FIG. 4 is a flow chart of the method for making a melamine container with dual-side patterns according to the present invention,

FIG. 5 is a cross-sectional view of a melamine container with dual-side patterns made with the method of the present invention; and,

FIG. 6 is a cross-sectional view of another melamine container with dual-side patterns made with the method of the present invention.

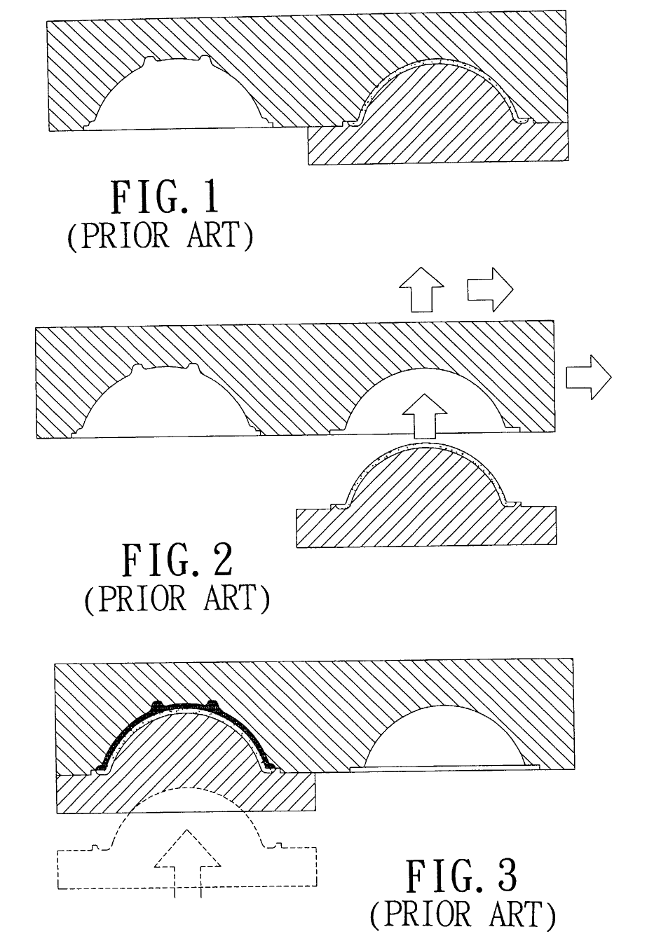

### DETAILED DESCRIPTION OF THE PREFERRED EMBODIMENTS

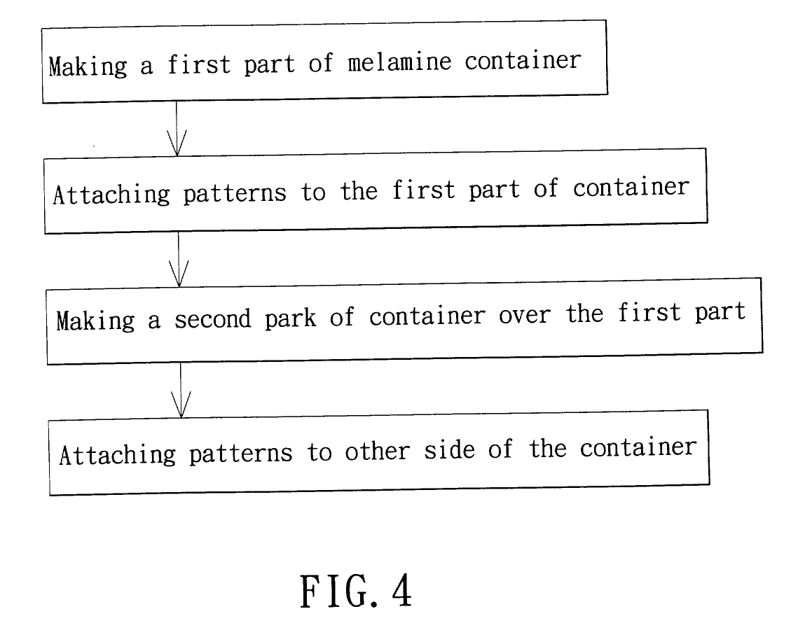

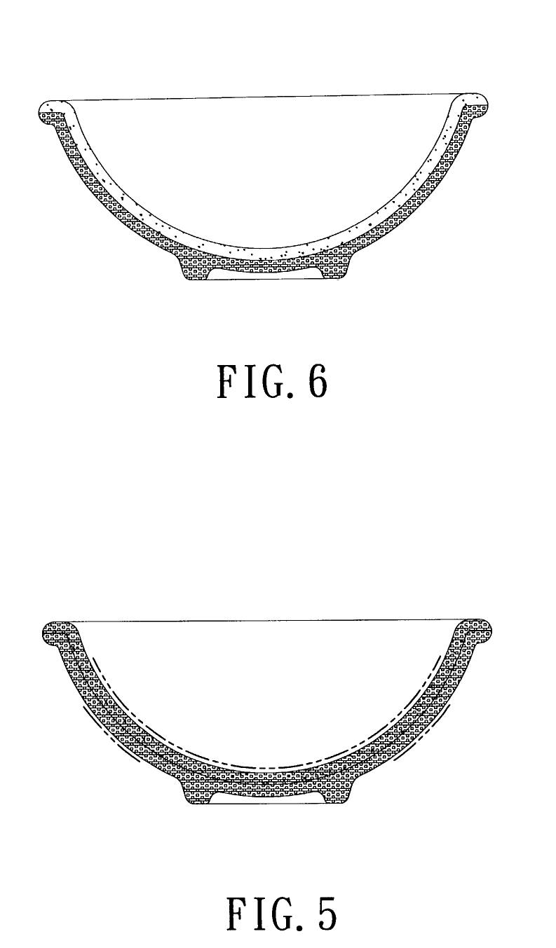

Referring to FIG. 4, a method for making a melamine container with dual-side patterns according to the present invention includes steps as followings:

(1) Making a first part of a melamine container, including the following actions: making a first and a second molds, fitting the first and the second molds respectively to a first and a second machines, and molding a first part of a container by means of injecting melamine materials into the first mold; the first mold including a male part, and a female part;

(2) Forming patterns on the first container part, including the following actions: separating the male part of the first mold from the molded first container part for uncovering an inner side of the first container part, and attaching a first pattern to the inner side of the molded first container part with a pattern attaching machine (not shown);

(3) Making a second part of the melamine container; including the following actions: repositioning the first container part onto a male part of the second mold, closing a female part of the second mold with the male part of the second mold, and injecting melamine materials into the second mold to form a second part of the container over the first container part; thus, the first and the second container parts are joined to each other to form a container; the male part of the second mold having the same shape as that of the first mold; the second mold being made in such a manner that a thickness of the second container part is substantially equal to that of the first container part, i.e. a thickness of the first container part is substantially one half of that of the melamine container.

(4) Forming patterns on the second container part, including the following actions: separating the female part of the second mold from the container for uncovering an outer side of the second container part, and attaching a second pattern to the outer side of the second container part with a pattern attaching machine.

Furthermore, the melamine materials used in the third step can be different from those used in the first step such that the first and the second container parts are different colors, helping increase attractiveness of the containers.

From the above description, it can be easily understood that the method for making a melamine container with dual-side patterns according to the present invention has advantages as followings:

1. Using two molds to make melamine containers with patterns being formed on inner and outer sides of the containers during the course of molding, the present method allows containers to be manufactured with patterns being formed on the same locations and with uniform quality. Therefore, this method makes melamine containers with dual-side patterns easily available, which are relatively attractive and fancy as compared with conventional melamine containers with single-side patterns.

2. Because two molds and two machines are used in the present method, the molding and the pattern attaching processes are relatively smooth and uninterrupted. Consequently, melamine containers with dual-side patterns can be manufactured efficiently.

3. While the second mold is used for making the second container part with, the first mold is also used for making another first container part so the molds do not have a standby period, which would cause them to become cool, and need to be preheated before each injection molding process. Therefore, time and energy are saved.

4. The first and the second container parts can be different colors for the melamine containers to be more attractive with the present method.

What is claims is:

1. A method for making a melamine container with dual-side patterns, comprising
a first step: molding a first part of a container by means of injecting melamine materials into a first mold including a male part, and a female part;
a second step: separating the male part of the first mold from the molded first container part to uncover an inner side of the first container part, and attaching a first pattern to the inner side of the first container part;
a third step: repositioning the first container part in a second mold, which consists of male, and female parts, and injecting melamine materials into the second mold to form a second container part over the first container part so that both of the container parts are joined to each other to form a container; the male part of the second mold being the same as that of the first mold; and,
a fourth step: separating the female part of the second mold from the container to uncover an outer side of the container, and attaching a second pattern to an outer side of the container.

2. The method for making a melamine container with dual-side patterns as claimed in claim 1, wherein the second mold is made such that a thickness of the second container part is substantially equal to that of the first container part.

3. The method for making a melamine container with dual-side patterns as claimed in claim 1, wherein the first and the second container parts are different colors.
